(19) United States
(12) Patent Application Publication
(10) Pub. No.: US 2008/0152854 A1
(43) Pub. Date: Jun. 26, 2008

(54) DAMPING TAPE AND ARTICLES COMPRISING SAME

(75) Inventors: Raul Maldonado Arellano, San Luis Potosi (MX); Vladimir A. Escobar Barrios, San Luis Potosi (MX); Octavio Gonzalez Rodea, San Luis Potosi (MX)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/960,945

(22) Filed: Dec. 20, 2007

(30) Foreign Application Priority Data
Dec. 20, 2006 (MX) 2006/015182

(51) Int. Cl. B32B 33/00; B32B 3/06

(52) U.S. Cl. 428/41.8; 428/99

(57) ABSTRACT

A damping tape comprising:
(a) a backing comprising a thermoplastic film having front and rear major surfaces; and
(b) a sheet of resilient fibers having anchor portions bonded to the film at bonding locations spaced along the front surface of the backing, and arcuate portions projecting from the front surface of backing between the bonding locations, the lengths of some of the fibers in the sheet may be disposed in various different directions with respect to each other; and
(c) a layer of adhesive covering significant portions of the rear surface of the backing. The tape may further comprise optional release liner over the adhesive layer. In some embodiments, the sheet of fibers may be covered with an overcoat layer.

### CROSS-REFERENCE TO RELATED APPLICATION

This application claims the benefit of Mexican Application No. 2006/015182, filed Dec. 20, 2006.

### TECHNICAL FIELD

The present invention refers to self-adhesive damping tapes and articles made with such tapes. The damping tapes are well suited for use in a variety of applications to reduce the effects of vibration including but not limited to electronics such as televisions, monitors, radios, speakers, computer printers, computers, etc.

### BACKGROUND

Vibrational damping materials have been used to reduce the effects, e.g., disruption and/or damage, caused by vibrations for many years in applications where vibrational energy, e.g., transmitted by the operation of machines or equipment, is encountered.

Illustrative examples of commercially successful damping materials include the 434, 435, 436, 4014 and 2552 “Damping Foils” from 3M Company. These tapes comprise viscoelastic polymers and thin aluminum sheets that allow the dissipation of the energy transmitted by vibrations or impacts. The introduction of viscoelastic polymers as pressure sensitive adhesives facilitated their adhesion to low or high-energy surfaces. Another example of commercially successful damping materials include tapes made with copolymers of isooctyl acrylate and acrylamide which can function both as bonding adhesives and as vibrational insulators of two joined surfaces or members. The acrylic copolymer foam provides a high bonding force between polyolefin or metal surfaces while insulating the two surfaces from direct contact with each other thereby reducing the potential for damages due to rubbing or repeated direct impact if subjected to vibration or resonance phenomenon. Illustrative examples of this kind of product are 3M™ VHB™ Tapes, e.g., Tape Nos. 4611, 4910, 4920, and 4929, and others.

For some applications such as the assembly of plastic or metal structures with close proximity and other reduced spaces many known tapes have important limitations. For example, in applications of assembly of television modules or computer screens, the available spaces for the placement of damping tapes are typically rather limited because of the design of the outer shells themselves. If there is a desire to do reprocessing operations within assembled units, disassembly of the structures must be possible.

The need exists for new, high performance, low cost damping tapes that meet one or more of these criteria.

### SUMMARY

The present invention provides new damping tapes that exhibit numerous desirable properties, making them advantageous for many applications. The invention also provides articles made with such damping tapes.

In brief summary, a damping tape of the invention comprises:

(a) a backing comprising a thermoplastic film having front and rear major surfaces; and

(b) a sheet of resilient fibers having anchor portions bonded to the film at bonding locations spaced along the front surface of the backing, and arcuate portions projecting from the front surface of backing between the bonding locations, the lengths of some of the fibers in the sheet may be disposed in various different directions with respect to each other; and

(c) a layer of adhesive covering significant portions of the rear surface of the backing. The tape may further comprise optional release liner over the adhesive layer. In some embodiments, the sheet of fibers may be covered with an overcoat layer.

In use, the damping tape is secured to a surface of a substrate with the layer of adhesive, thereby protecting the surface and underlying article from effects of impact and vibration. Tapes of the invention can be easily applied in restricted spaces, use of an adhesive exhibiting pressure sensitive adhesion providing instant adhesion to keep the tape in place pending further assembly of the article and/or further build of adhesion, e.g., through residence in place on the surface or some form of activation.

### BRIEF SUMMARY OF DRAWING

The invention will be further explained with reference to the drawings wherein

FIG. 1 is a perspective view of a portion of an embodiment of a tape of the invention;

FIG. 2 is a cross section showing an article of the invention; and

FIG. 3 is a graph showing performance of some embodiments of the invention.

The figures are intended to be merely illustrative and non-limiting and are not to scale.

### DETAILED DESCRIPTION OF ILLUSTRATIVE EMBODIMENTS

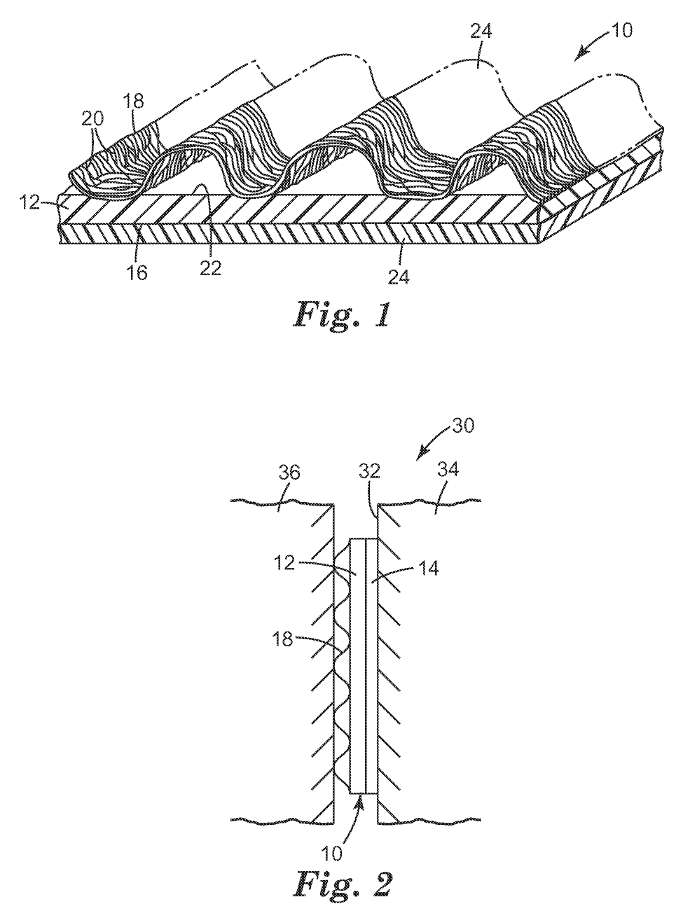

An illustrative embodiment of the tape of the invention is shown in FIG. 1 where tape 10 comprises backing 12, adhesive layer 14 on rear major surface 16 thereof, and sheet 18 of resilient fibers 20 on front major surface 22 thereof. Tape 10 further comprises overcoat 24 over sheet 18.

An illustrative article of the invention is shown in FIG. 2 where article 30 has tape 10 mounted on a portion of surface 32 of first member 34, i.e., the portion is referred to as a damped zone. Tape 10 is positioned so as to damp the effects of vibrations which might cause member 36 to vibrate against member 34.

The backing is a film, preferably an extruded thermoplastic film. As discussed below, tapes incorporating such films as backings can be readily made.

The backing film is typically a polyolefin-comprising polymer or copolymer with polypropylene being typically preferred. Those skilled in the art can readily select suitable materials based in part upon the application for which the damping tape is being made.

On the front major surface of the backing is a cushioning layer made up of a sheet of resilient fibers. The cushioning layer serves to absorb and dissipate vibrational energy, thereby protecting the substrate with which the damping tape is used. During impact of a vibration, e.g., pushing a member of an assembly against another member having a tape of the invention on the surface thereof, the fibers in the cushioning layer will deform and the cushioning layer will compress absorbing energy. When the two members move apart as the vibration continues, the cushioning layer will decompress and the fibers change from their deformed state. Typically the fibers will be selected such that they can undergo many, perhaps even thousands or more, of vibrational impacts to return to their initial shape. As used herein, assembly refers to an article or aggregation of parts wherein two members are disposed in vibrational relation with one another, i.e., in the event that one of the members is subjected to vibrational energy it will contact the other member. The two members may distinct portions of a single component, e.g., a panel of metal that is folded back on itself, or may be separate components, e.g., the side of the outer shell of a television cabinet and the chassis of the electronic apparatus contained therein.

The fibers may be of many polymeric materials such as polypropylene, polyethylene, polyester, nylon or polyamide, or combinations of such materials such as a core of polyester and a sheath of polypropylene which provides relatively high strength due to its core material and is easily bonded due to its sheath material. In many embodiments, fibers are preferably made from polypropylene or polyamide. As desired fibers of only a single material or fibers of different materials or material combinations may be used in the same sheet of fibers.

Preferably the sheet of fibers is a non-woven web. Such sheets can be readily and cost effectively made with desired properties. Such sheets with backings suitable for the invention have been known for use as loop material in so-called hook and loop fasteners. The versions of such sheets with backings known as extrusion-bonded-loop or EBL sheets are typically well suited for this invention. The non-woven structure can be made by any of several known method, for example, using a carder-type system, as described in European Patent No. 0539504, and U.S. Pat. Nos. 5,256,231, 5,611,791, 5,616,394, and 5,643,397. Each of these is incorporated herein by reference in its entirety.

The fibers in the sheet of fibers can be disposed in various directions with respect to the bonding locations and may or may not be bonded together at crossover points in the arcuate portions; can be disposed in various directions with respect to the bonding locations with the majority of the fibers in the sheet of fibers, i.e., over 80 or 90 percent, extending in directions at about a right angle to the bonding locations if they are arranged in parallel; or all of the individual fibers in the sheet of fibers can extend in directions generally at right angles to the spaced generally parallel bonding locations.

In a typical embodiment, the cushioning layer will have a thickness of from about 0.5 millimeters up to about 2 millimeters, depending on the weight and on the length of the non-woven fibers. If desired, cushioning layers having thicknesses outside these ranges may be used in accordance with the invention.

The cushioning sheet will be selected dependent in part upon the damping characteristics desired. For instances where damping of lower energy vibrations is desired, relatively more compressible materials will be selected whereas in instances where higher energy vibrations are to be addressed, the cushioning layer will typically be selected to somewhat less compressible.

An illustrative method of the invention for making damping tape of the invention is as follows: arranging a sheet of polymeric fibers and conforming it so that the sheet of fibers has arcuate portions projecting in the same direction from spaced anchor portions of the sheet of fibers, and then forming at least a portion of a backing around the spaced anchor portions of the sheet of fibers by extruding thermoplastic material onto the anchor portions of the sheet of fibers so that the arcuate portions of the sheet of fibers project from a front surface of the newly formed backing.

Such forming of the sheet of fibers is preferably done by providing first and second generally cylindrical corrugating members each including a plurality of uniformly spaced ridges defining its periphery, mounting the corrugating members in axially parallel relationship with portions of the ridges of the corrugating members in mesh with each other, rotating at least one of the corrugating members, feeding the sheet of fibers between the meshed portions of the ridges of the rotating corrugating members to generally conform the sheet of fibers to the periphery of the first corrugating member, thereby forming the arcuate portions of the sheet of fibers in spaces between the ridges of the first corrugating member and the anchor portions of the sheet of fibers along outer surfaces of the ridges of the first corrugating member, and retaining the formed sheet of fibers along the periphery of the first corrugating member after it has moved past the meshing portions of the ridges. At least a portion of the backing (or the entire backing) is then formed around the anchor portions of the sheet of fibers by extruding the molten thermoplastic material onto the anchor portions of the sheet of fibers while those anchor portions are on the end surfaces of the ridges on the first corrugating member. Such forming of the backing around the anchor portions of the sheet of fibers provides the advantage compared to sonic welding or other forms of heat fusion of the fibers to a pre-formed backing that the fibers in the anchor portions are generally non-deformed (even though the outer fibers in the anchor portions may be slightly flattened) and thus the individual fibers retain most of their initial strength adjacent the bonding location, while with the proper combination of materials the surface of the fibers can be fused to the backing material to firmly anchor the fibers in the backing; and the resultant thermoplastic layer in which the fibers are bonded has generally uniform morphology throughout (even though the morphology of the backing may be slightly altered around the anchor portions of the sheet of fiber due to their effect as a heat sink), rather than having different morphological structures in large portions extending through the backing through which sonic energy or other sources of heat were applied to bond the anchor portions of the sheet of fibers to the backing compared to adjacent portions of the backing, which differences in morphological structures typically weakens the backing. The thermoplastic material extruded onto the anchor portions of the sheet of fibers can be of the type that solidifies as it cools, or can be of the type called reactive hot melts that partially solidify as they cool and then cross link as a result of exposure to an external element such as atmospheric moisture or ultraviolet radiation. Also, the thermoplastic material can be extruded onto both the anchor portions of the fibers and onto an adjacent surface of a sheet of backing material intended to be incorporated into the backing (e.g., a layer of polymeric film or a layer of adhesive) or onto both the anchor portions of the fibers and onto an adjacent surface of a sheet of support material intended to shape or retain the shape of the backing as it cures, which sheet of support material can later be stripped away.

Preferably the thermoplastic material is extruded onto the anchor portions of the sheet of fibers just prior to a nip between the first corrugating member and a cooling roller. The cooling roller then either forms the surface of the backing opposite the sheet of fibers when the backing is formed only of the extruded thermoplastic material, or guides along its surface any sheet of backing material or support material intended to be incorporated into or support the backing so that the cooling roller brings that sheet of backing or support material into intimate contact with the side of the molten thermoplastic material opposite the anchor portions of the sheet of fibers in the nip between the cooling roller and the first corrugating roller.

When the cooling roller is rotated at a slower peripheral speed (e.g., one quarter or one half the peripheral speed) than the first corrugating roller, the anchor portions of the sheet of fibers along the ridges of the first corrugating roller will be pushed closer together in the molten layer of extruded thermoplastic material at the nip between the first corrugating roller and the cooling roller, resulting in a sheet of loop material that has more loop portions per square inch and a greater basis weight for the sheet of fibers than when the peripheral speeds of the first corrugating roller and the cooling roller are the same. This technique for increasing loop portions and basis weight of the sheet of fibers on the sheet of loop material is useful both to make sheets of loop materials having different numbers of loop portions per centimeter of backing length using the same equipment, and to make sheets of loop materials with more loop portions per centimeter of backing length than could be formed between ridges machined on the corrugating members because of physical limitations involved in machining such ridges close together.

The ridges of the corrugating members can be elongate and generally parallel so that the bonding locations are also elongate and generally parallel and are continuous in one direction across the front surface of the backing so that continuous rows of the arcuate portions extend across the backing of the sheet of loop materials or alternately the ridges can be elongate, generally parallel, and in a regular pattern-of discontinuous lengths so that the parallel bonding locations are also in a regular pattern of discontinuous lengths to form a regular pattern of discontinuous rows of the arcuate portions of the sheet of fibers along the front surface of the backing. Also it is contemplated that the ridges of the first corrugating member can form interlocking closed patterns (e.g., in the shape of circles, diamonds, octagons, letters, numbers, etc.) to form corresponding patterns for the arcuate portions of the fibers along the front surface of the backing, in which case the second corrugating member will be formed with post like ridges to press the sheet of fibers into the centers of the closed patterns.

Elongate ridges on the corrugating members can be oriented parallel to axes of the corrugating members, or at right angles to the axes of the corrugating members with the corrugating members extending around the corrugating members, or at many other angles with respect to the axis of the corrugating members so that the rows of arcuate portions of the sheet of fibers, whether continuous or discontinuous, can be oriented along or transverse to the sheet of fibers fed between the corrugating member or at many angles therebetween.

A similar manufacturing process is disclosed in U.S. Pat. No. 5,616,394 (Gorman et al.) which is incorporated herein by reference in its entirety.

If desired, damping tapes of the invention may further comprise an overcoat on the outer side of the cushioning layer, i.e., the side opposite to the backing. The overcoat may range in thickness from relatively thin, substantially cover individually or in small groups, to relatively thicker forming a substantially continuous layer. The overcoat is typically applied after the backing and cushioning layer are formed and bonded to one another.

An illustrative overcoat can be of the aliphatic urethane type in an aqueous emulsion to which it is also possible to incorporate acrylic components also in an aqueous emulsion, with the purpose of improving the abrasion resistance or reduce the wear due to rubbing. Illustrative examples include polyurethane emulsions having a glass transition temperature lower than about −20° C. and the capability to self-reticulate under heat at temperatures of from about 80° C. to about 120° C., or otherwise they may have functional groups to react with reticulant agents such as those derived from urea-formaldehyde or polyfunctional aziridine compounds. Other illustrative examples include acrylic compositions with a glass transition temperature lower than about −5° C., produced as an aqueous emulsion with up to about 70% of solids and which are capable of self-reticulating or otherwise, being able to be reticulated with urea-formaldehyde or polyfunctional aziridine compounds.

The overcoat can be applied by many known techniques including spraying, knife or bar coating, roll coating, etc. Selection of the method will be dependent in part upon the nature of the materials selected for the components of the tape. Illustrative systems include those using cylinders placed one above the other; the cylinders may be made of steel or of synthetic rubber, and have engravings shaped as cells. Examples of these rollers are those commercially sold to apply emulsion coatings with binder agents, used in the reinforcement of fabrics or non-woven webs; such cylinders have cells shaped as hollow pyramids with or without tip, where the base of the pyramid faces outward and the pyramids are distributed throughout the surface of the cylinder. The pyramids are filled with the polymer coating and the polymer coating is applied on the non-woven structure at the time that this structure goes through the space created between the two cylinders. To manufacture the product object of the present invention, cylinders with a cell distribution of between 14 and 34 cells/centimeter² are suitable in some embodiments, preferably 1 cells/centimeter², made of any suitable material, for example, stainless steel or synthetic rubber. An alternative to this type of cylinders are those made of a steel cylinder on which is placed a layer which may be removable or not of silicone rubber, which has the mentioned cell distribution. The system of rollers can operate at a speed of from about 5 to about 60 linear meters/minute, preferably about 30 meters/minute, aided by a drying oven with temperatures of from about 80° C. to about 120° C., preferably about 95° C. The pressure exerted by the two rollers in the application system ranges from about 703 to about 2111 grams/centimeter², preferably. It is also possible to apply the polymer overcoat using a spray system, for example, with equipment using pressured air.

Damping tapes of the invention comprise an adhesive layer on the rear major surface of the backing.

The selection of a suitable adhesive composition is dependent in part upon the nature of the backing, the nature of the intended substrate to which the tape will be applied, the manner in which the tape will be applied, the conditions underwhich the tape will be expected to perform (e.g., immersion in water, temperature, moisture, etc.), and whether it is desired that the tape be easily removable from the substrate or not, either soon after application or after extended use.

Typically, it is preferred that the adhesive be pressure sensitive in character. Illustrative examples of suitable adhesives include water-based or solvent-based acrylic adhesives. In some embodiments, however, other adhesive systems such as those activated by irradiation with, e.g., heat, e-beam, ultraviolet radiation, etc. or by chemical exposure may be used.

In some embodiments, the adhesive layer will be substantially continuous over the substantially the entirety of the rear major surface of the backing. In other embodiments, however, the adhesive layer may be made in discontinuous fashion with, e.g., slit-like discontinuities or even broader openings or gaps, if desired.

In some embodiments, the adhesive layer has a thickness of from about 0.1 to about 1 millimeter. Thicknesses outside this range may be used if desired.

An illustrative pressure sensitive adhesive composition useful for many applications is an acrylic-type that includes a copolymer of isooctyl acrylate and acrylamide in a ratio of from about 90/10 to about 95/5 parts per hundred total parts, respectively, or a copolymer of isooctyl acrylate and acrylic acid in a ratio of 90/10, 95/5, and 97.5/2.5 parts per hundred total parts; or 2-ethylhexyl acrylate and acrylamide copolymer in a ratio of 90/10, 95/5, and 97.5/2.5 parts per hundred total parts of mixture solution, or combinations of these copolymers with acrylic copolymers of the company Rohm & Haas (Philadelphia, Pa., U.S.A.) commercialized under the trade name of ROBOND® in ratios of from about 1 to about 15 parts of the ROBOND® emulsion per hundred total parts of the mixture, preferably around 10 parts.

For the combinations are also included acrylic-type pressure sensitive adhesives from Stahl Company (Waalwijk, Holland) and the adhesives made with copolymers of vinyl acetate and acrylic copolymers such as those commercialized by the company Air Products (Allentown, Pa., U.S.A.), in combinations of from about 1 to about 20 parts of the adhesives of Stahl to Air Products per hundred total parts of the mixture, preferably about 5 to about 10 parts.

As bonding resins it is possible to use rosin-type resins, polyterpenic and hydrocarbonated aliphatic resins, being added in ratios from about 5 to about 40 parts per each hundred total parts of mixture solution, preferably around 25 parts.

The use of some of the combinations of the adhesives and of the bonding resins depends on the final application and of the resulting additional cost, as is apparent to one skilled in this art.

If desired, the adhesive layer may be formulated with one or more additional adjuvants such as flame-retardant agents, e.g., selected from the group consisting of carbon black or triaryl phosphate esters; colorants; antioxidants; adhesion promoters; fillers; etc. As will be understood, other components in the damping tape may comprise one or more such adjuvants.

Application a suitable adhesive to the rear major surface of the backing can be achieved through many techniques, typically selected in part based upon the speed of manufacture, the characteristics of the backing and the adhesive, etc. Some illustrative techniques include extrusion, coating, etc.

To improve the holding (adhesion) of the adhesive on the backing, it is possible to use known methods that promote a better interaction that prevent the separation of the adhesive from the end product. Illustrative examples include corona treatment and application of a primer on the surface to which the adhesive will be applied.

Tapes of the invention are typically wound into roll form. If desired, other dispensing arrangements such as stacked sheets may be used if desired.

To avoid the formation of a momentary or permanent binding of the cushion layer of an underlying portion with the adhesive layer of an overlying portion, it is typically preferred to use a release agent, e.g., coated or applied to the cushion layer, or a release liner, e.g., a sheet removably adhered to the exposed surface of the adhesive layer. Choice of an appropriate release agent and/or release liner, or even the need to have any such component, will be dependent in part upon the nature of the cushion layer, overcoat, if any, and adhesive layer.

Illustrative examples of release agents that can be applied to the cushion layer include the polysiloxane or urea type solutions or combinations of the two. Examples of these types of release agents are those manufactured by 3M Company (St. Paul, Minn., U.S.A.) under the RD codes. The application systems of these release agent solutions are known in the state of the art, among them are the application mechanisms using impregnation rollers, spray equipment and pressure drip.

These same agents may be applied on a sheet of paper with the purpose to protect the adhesive coated on the polyolefin film until the time when is desired to be used; examples of these types of paper sheets are those marketed by the company Loparex LLC (Willowbrook, Ill., U.S.A.).

Generally it will be preferred that the overcoat be substantially co-extensive with sheet of fibers of the cushioning layer. In many embodiments, the cushioning layer, backing, and adhesive layer will be substantially co-extensive, however, embodiments where this is not so may be made in accordance with the present invention. Tapes of the invention may be made of any desired color or colors. Tapes of the invention will typically be wound into roll form, but may be made in other configurations as desired, e.g., sheets which might be stacked or held on place on a release liner, etc.

Some illustrative embodiments of tapes of the invention include:

Alpha: non-woven polypropylene fibers, acrylic polymer overcoat, pressure sensitive adhesive (with service range of from about −7° C. to about 130° C.) useful, e.g., for television cabinets and computers;

Beta: non-woven polypropylene fibers, acrylic polymer overcoat, pressure sensitive ethylene-vinyl acetate copolymer adhesive (with service range of from about 2° C. to about 100° C.) useful, e.g., home appliances;

Gamma: non-woven polyamide fibers, polyurethane/acrylic polymer overcoat, pressure sensitive acrylic and ethylene-vinyl acetate copolymer adhesive (with service range of from about 2° C. to about 110° C.) useful, e.g., sound dampening in automobiles; and

Delta: non-woven polypropylene fibers, polyurethane and/or acrylic polymer overcoat, pressure sensitive acrylic adhesive (with service range of from about −30° C. to about 110° C.) useful, e.g., damping in building structures.

The selection of the combinations will depend on the final use to which the tape will be put.

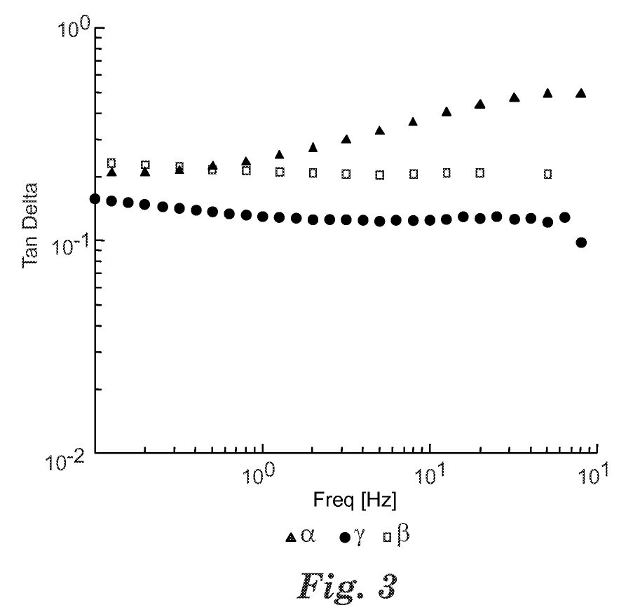

FIG. 3 shows the dynamic-mechanical analysis of some illustrative combinations of materials of the present invention. The tan delta value curves that were obtained from each sample are observed in this dynamic-mechanical analysis. For a high tan delta value, a better damping performance is obtained, because the viscous behavior prevails over the elastic behavior, which causes the vibration stresses to be dissipated in an effective way. Models alpha (α), beta (β) and gamma (γ) of Table 2 are shown in FIG. 3. It should be noted that the damping performance may be adjusted as desired through selection of the combination of components chosen.

The present invention provides a tape useful, e.g., for the reduction of damages caused by vibrations or impacts as well as for separating the surfaces, made with a non-woven structure coated with a polymer and a pressure sensitive adhesive, to be applied on polyolefin or metal structures found in modules, monitors, plates, panels, molded pieces and electronic equipment cabinets, home appliances, car interiors and window components and building frames.

In various embodiments the present invention has the capability of dissipating the energy originating from vibrations or impacts, as well as isolating the surfaces with which it makes contact, so that less amount of energy is transmitted to other parts of the surfaces. This is particularly important in applications such as electronic equipment, home appliances and car interiors, because the transfer of energy originating from vibrations and impacts can damage the operational and functional components, and may alter the final performance achieved by the end user or customer or may cause a critical failure in the normal operation of the item.

Particular illustrative examples showing the construction of the tape object of the present invention are shown below:

### Example 1

A tape sample constructed with a non-woven fiber structure of 8 centimeters of length and 6 decitex was distributed in the shape of curls and waves over an extruded polypropylene film that contained carbon black as flame retardant.

The fiber weight was 25 grams/meter², while the film weight was 75 grams/meter². The non-woven structure was coated with a 70% solids acrylic polymer which was applied with a system of stainless steel cylinders with cells arranged in an arrangement of 17 cells/centimeter² and under a coating speed of 20 linear meters/minute.

The non-woven structure coated with the acrylic polymer was placed into an oven that had temperatures of from about 80° C. to about 95° C.

The non-woven structure was given a Corona treatment to achieve 35 dynes/centimeter on the free side of the polypropylene film, being coated later with a pressure sensitive adhesive made with a 30% solids copolymer solution constituted by 95 parts by weight of isooctyl acrylate and 5 parts by weight of acrylamide; the adhesive was applied in a sufficient amount to reach a thickness of from about 0.25 to about 0.3 millimeter. The application of this adhesive was done using a fountain-type die that was fed with a peristaltic pump at a speed of from about 10 to about 15 kilograms/minute.

The adhesive solution had a viscosity of from about 3000 to about 5000 centipoises. The construction was completed with the application of a release agent on the non-woven fiber side, like for example the RD1530 of 3M Company at 2% of total solids.

### Example 2

A tape constructed with a non-woven fiber structure of 7 centimeters of length and 10 decitex, was distributed in the shape of curls and waves over an extruded polypropylene film that contained a compound of triaryl phosphate ester as flame retardant.

The fiber weight was 28 grams/meter², while the film weight was 72 grams/meter². The non-woven structure was coated with a 50% solids acrylic polymer solution, which was applied with a spray system at 1.0 kilograms/centimeter² of air pressure and under a coating speed of about 30 linear meters/minute.

The acrylic polymer was reticulated with a urea-formaldehyde compound in an oven that had temperatures of from about 75° C. to about 85° C.

The non-woven structure was given a Corona treatment to achieve 35 dynes/centimeter on the free side of the polypropylene film, being coated later with a 75% solids pressure sensitive adhesive made with an ethylene-vinyl acetate copolymer; the adhesive was added with 5 parts per 100 total parts of triaryl phosphate ester and it was added in a sufficient amount to achieve a thickness of from about 0.3 to about 0.4 millimeter.

The application of this adhesive was done using a drop die with a space between its lips of from about 0.051 to about 0.076 millimeters, made of stainless steel and fed with a peristaltic pump at a speed of from about 20 to about 25 kilograms/minute.

The adhesive solution had a viscosity of from about 6000 to about 7000 centipoises. The construction was completed with the placement of a sheet of paper coated with a polysiloxane release agent on the non-woven fiber side.

### Example 3

A tape constructed with a non-woven fiber structure of 6 centimeters of length and 7 decitex, was distributed in the shape of curls and waves over an extruded polypropylene film that contained carbon black as flame retardant.

The fiber weight was 40 grams/meter², while the film weight was 60 grams/meter². The non-woven structure was coated with a 60% solids mixture of urethane/acrylic polymer in a ratio of 95/5 parts per each 100 total parts, respectively, being applied with a system of synthetic rubber rollers that had cells arranged in an arrangement of about 17 cells/centimeter² and at a coating speed of about 20 linear meters/minute.

The aliphatic urethane polymer was reticulated in an oven that had temperatures of between 80° C. and 95° C. The non-woven structure was given a Corona treatment to achieve 35 dynes/centimeter on the free side of the polypropylene film, being coated later with a 70% solids pressure sensitive adhesive made of an acrylic copolymer constituted by 27 parts of isooctyl acrylate, 3 parts of acrylamide and 70 parts of an ethylene-vinyl acetate copolymer; the adhesive was applied in a sufficient amount to achieve a thickness of from about 0.15 to about 0.20 millimeter.

The application of this adhesive was done using a fountain-type die that was fed with a peristaltic pump at a speed of from about 10 to about 15 kilograms/minute.

The adhesive solution was added with carbon black as flame retardant agent and had a viscosity of from about 3500 to about 5000 centipoises. The construction was completed with the application on the non-woven fiber side of a release agent, such as for example the RD1530 of 3M Company at 2% of total solids.

### Example 4

A tape constructed with a non-woven fiber structure of 6 centimeters of length and 10 decitex, was distributed in the shape of curls and waves over an extruded polypropylene film that contained a compound of triaryl phosphate ester as flame retardant.

The fiber weight was 25 grams/meter², while the film weight was 75 grams/meter². The non-woven structure was coated with a 50% solids acrylic polymer, which was applied with a spray system at 1.0 kilogram/centimeter² of air pressure and under a coating speed of 30 linear meters/minute.

The acrylic polymer was self-reticulated in an oven that had temperatures of from about 85° C. to about 95° C. The non-woven structure was given a Corona treatment to achieve 35 dynes/centimeter on the free side of the polypropylene film, being coated later with a 30% solids pressure sensitive adhesive made of a copolymer constituted by 95 parts of 2-ethylhexyl acrylate and 5 parts of acrylic acid; the adhesive was added with 5 parts per 100 total parts of triaryl phosphate ester and was applied in a sufficient amount to achieve a thickness of between 0.7 and 1.0 millimeter.

The application of this adhesive was done using a drop die with a space between its lips of from about 0.051 to about 0.076 millimeters, made of stainless steel and fed with a peristaltic pump at a speed of 20 to 25 kilograms/minute.

The adhesive solution had a viscosity of from about 6000 to about 7000 centipoises. The construction was completed with the placement of a sheet of paper coated with a polysiloxane release agent on the non-woven fiber side.

The present invention has now been described with reference to several embodiments thereof. It will be apparent to those skilled in the art that many changes can be made in the embodiments described without departing from the scope of the present invention. Thus the scope of the present invention should not be limited to the structures described in this application, but only by structures described by the language of the claims and the equivalents of those structures.

What is claimed is:

1. A damping tape comprising:
(a) a backing comprising a thermoplastic film having front and rear major surfaces; and
(b) a sheet of resilient fibers having anchor portions bonded to said film at bonding locations spaced along said front surface of said backing, and arcuate portions projecting from said front surface between said bonding locations; and
(c) a layer of adhesive covering significant portions of said rear surface of said backing.

2. The tape of claim 1 wherein said backing is an extruded polypropylene film

3. The tape of claim 1 wherein said sheet of fibers is a non-woven fiber structure.

4. The tape of claim 1 wherein said sheet of resilient fibers comprises a plastic material selected from the group consisting of polyolefins, polypropylenes, polyamides, and mixtures or blends thereof.

5. The tape of claim 1 further comprising a polymer coating on said fibers.

6. The tape of claim 4 wherein said coating is selected from the group consisting of aliphatic-urethane polymers and acrylates.

7. The tape of claim 1 further comprising one or more adjuvants selected from the group consisting essentially of flame-retardant agents, colorants, antioxidants, adhesion promoters, and fillers.

8. The tape of claim 1 wherein said adhesive is a pressure sensitive adhesive.

9. The tape of claim 1 further comprising a release liner over said adhesive layer.

10. The tape of claim 1 wherein said bonding locations are elongate in shape and generally parallel in orientation, and said fibers are disposed in various directions with respect to said parallel bonding locations.

11. The tape of claim 10 wherein said bonding locations are generally straight and disposed in a rectangular pattern of discontinuous lengths so that the discontinuous rows of the arcuate portions along the front surface are generally rectangular.

12. The tape of claim 10 wherein said bonding locations are disposed in patterns so that the discontinuous rows of the arcuate portions along the front surface have shapes selected from the group consisting essentially of circles, diamonds, octagons, letters, numbers and symbols.

13. An assembly comprising a first member having a major surface and damping tape of claim 1 adhered to at least a portion of the major surface, the portion of the major surface being a damped zone.

14. The assembly of claim 13 further comprising a second member disposed in relational proximity to the damped zone.

15. The assembly of tape of claim 13 wherein assembly is selected from modules, monitors, plates, panels, molded pieces and electronic equipment cabinets, home appliances, car interiors, and building windows or frames.
